(19) United States
(12) Patent Application Publication
(10) Pub. No.: US 2019/0302952 A1
(43) Pub. Date: Oct. 3, 2019

(54) MOBILE DEVICE, COMPUTER INPUT SYSTEM AND COMPUTER READABLE STORAGE MEDIUM

(71) Applicant: Chicony Electronics Co., Ltd., New Taipei City (TW)

(72) Inventor: Yi-Hung Wang, New Taipei City (TW)

(21) Appl. No.: 16/026,519

(22) Filed: Jul. 3, 2018

(30) Foreign Application Priority Data
Mar. 28, 2018 (TW) 107110814

(51) Int. Cl. G06F 3/041; G06F 3/0488; G06F 3/0489; G06F 3/0482

(52) U.S. Cl. CPC G06F 3/0416; G06F 3/04886; H04W 4/80; G06F 3/0482; G06F 3/04897

(57) ABSTRACT

A computer input system including a computer device and a mobile device. The computer device includes a foreground detection module and a first communication module. The foreground detection module detects the usage status of the computer device to output foreground status information. The first communication module is electrically connected to the foreground detection module and outputs the foreground status information. The mobile device includes a second communication module, a touch screen, and a quick menu module. The second communication module is communicatively connected to the first communication module to receive the foreground status information. The quick menu module is electrically connected to the second communication module and the touch screen to provide and display a foreground quick menu on the touch screen according to the foreground status information. The foreground quick menu includes a plurality of foreground function options applicable to the foreground application.

### CROSS-REFERENCE TO RELATED APPLICATION

This non-provisional application claims priority under 35 U.S.C. § 119(a) to Patent Application No. 107110814 filed in Taiwan, R.O.C. on Mar. 28, 2018, the entire contents of which are hereby incorporated by reference.

### BACKGROUND

### Technical Field

The instant disclosure generally relates to an input system and, more particularly, to a computer input system, a mobile device, and a computer readable storage medium.

### Related Art

With the advancement of technology, computers (for example, desktop computers or notebook computers) have become a common tool for work or for entertainment in most people's daily lives. Users can use computers to execute the software they require, such as word processing software (including Microsoft Office and Google Docs), aided design software (including AutoCAD and Pro/ENGINEER), graphics/image software (including Adobe Photoshop and CorelDRAW), and audio/video playback software (including Media Player and RealPlayer), etc.

In the process of executing software, the functions of the software can be used in two ways. One is by selecting on the toolbar button and the drop-down menu or the pop-up menu provided by the software through mouse movement, but this often has to go through layers to find the desired function options, which severely affects the use efficiency. The other is to directly execute the corresponding software functions by pressing a shortcut key. However, since the software may provide a large number of functions, it is difficult for an ordinary user to remember the shortcut key corresponding to each of the functions. In addition, when the user switches between multiple applications, he/she is prone to confusion or mis-input.

### SUMMARY

In view of the above, in one embodiment, a computer input system is provided including a computer device and a mobile device. The computer device includes a foreground detection module and a first communication module. The foreground detection module detects the usage status of the computer device to output foreground status information. The foreground status information corresponds to a foreground application the computer device is currently executing in a foreground. The first communication module is electrically connected to the foreground detection module and outputs the foreground status information. The mobile device includes a second communication module, a touch screen, and a quick menu module. The second communication module is communicatively connected to the first communication module to receive the foreground status information. The quick menu module is electrically connected to the second communication module and the touch screen to correspondingly provide and display a foreground quick menu on the touch screen according to the foreground status information. The foreground quick menu includes a plurality of foreground function options applicable to the foreground application.

In one embodiment, a mobile device is provided including a communication module, a quick menu module and a touch screen. The communication module receives external foreground status information. The foreground status information corresponds to a foreground application being currently executed. The quick menu module is electrically connected to the communication module such that the quick menu module provides a foreground quick menu according to the foreground status information. The touch screen is electrically connected to the quick menu module to display the foreground quick menu. The foreground quick menu comprises a plurality of foreground function options applicable to the foreground application.

In one embodiment, a computer readable storage medium is provided with a computer program applicable to a mobile device. The mobile device includes a touch screen. The computer program is capable of being downloaded into the mobile device to execute the following steps. External foreground status information is received corresponding to a foreground application. A foreground quick menu is provided according to the foreground status information. The foreground quick menu comprises a plurality of foreground function options applicable to the foreground application. The foreground quick menu is displayed on the touch screen.

According to the embodiments of the instant disclosure, the mobile device (for example, a smart phone or a tablet computer) displays foreground function options applicable to a foreground application according to the foreground application the computer device (for example, a notebook computer or a desktop computer) is currently executing in a foreground. Therefore, the user can directly select from the foreground function options by touch such that the foreground application quickly executes the corresponding function. Accordingly, the user does not need to go through the layers to find the desired function options or remember the keyboard shortcut corresponding to each of the functions, thereby achieving the advantages of more intuitive and convenient operation.

### BRIEF DESCRIPTION OF THE DRAWINGS

This disclosure will become more fully understood from the detailed description given herein below for illustration only, and thus not limitative of this disclosure, wherein:

FIG. 1 is a perspective view of a computer input system according to a first embodiment of the instant disclosure;

FIG. 2 is a system block diagram of a computer input system according to a first embodiment of the instant disclosure;

FIG. 3 is a flowchart showing the steps of loading a computer program into a mobile device according to a first embodiment of the instant disclosure;

FIG. 4 is a flowchart showing the steps of loading a computer program into a mobile device according to a second embodiment of the instant disclosure;

FIG. 5 is a schematic diagram of a computer device according to a first embodiment of the instant disclosure;

FIG. 6 is a schematic diagram showing the use of a mobile device according to a first embodiment of the instant disclosure;

FIG. 7 is another schematic diagram of a computer device according to a first embodiment of the instant disclosure;

FIG. 8 is another schematic diagram showing the use of a mobile device according to a first embodiment of the instant disclosure;

FIG. 9 is a schematic diagram showing the operation of a mobile device according to a first embodiment of the instant disclosure;

FIG. 10 is a flowchart showing the step of loading a computer program into a mobile device according to a third embodiment of the instant disclosure;

FIG. 11 is a flowchart showing the step of loading a computer program into a mobile device according to a fourth embodiment of the instant disclosure; and

FIG. 12 is a system block diagram of a computer input system according to a second embodiment of the instant disclosure.

### DETAILED DESCRIPTION

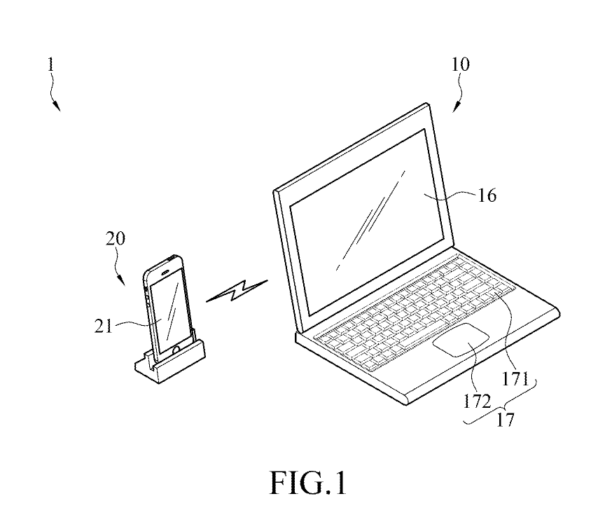

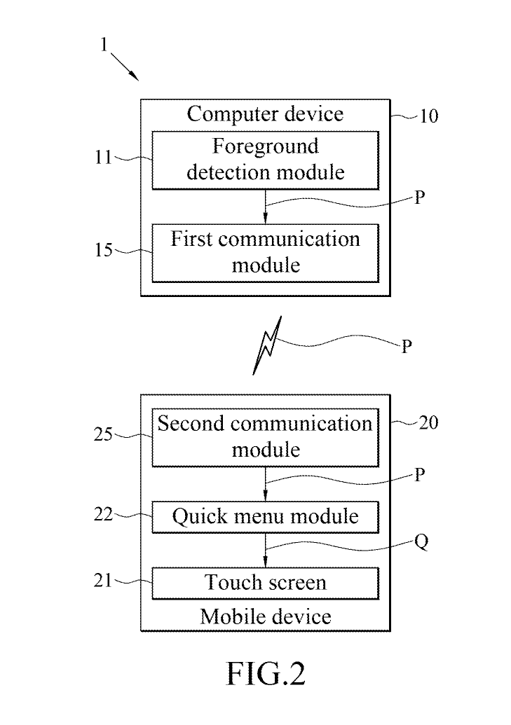

FIG. 1 is a perspective view of a computer input system according to a first embodiment of the instant disclosure, and FIG. 2 is a system block diagram of a computer input system according to a first embodiment of the instant disclosure. As shown in FIG. 1 and FIG. 2, the computer input system 1 includes a computer device 10 and a mobile device 20. In some embodiments, the computer device 10 may be a notebook computer or a desktop computer, and the mobile device 20 may be a smart phone, a tablet computer or a personal digital assistant.

As shown in FIG. 1, in this embodiment, the computer device 10 is exemplified by a notebook computer. The computer device 10 may include a display screen 16 and an input device 17. Here, the input device 17 includes a keyboard 171 and a touch pad 172. Among them, the keyboard 171 is used for a user to input a character, and the touch pad 172 can sense a user's hand movement to control the cursor. As shown FIG. 2, the computer device 10 may include a foreground detection module 11 and a first communication module 15. The first communication module 15 may be a wireless communication module, for example, a Wi-Fi module, an 802.11 module, a Bluetooth module or a ZigBee module, for wireless signal or data communication. Alternatively, in another embodiment, the first communication module 15 may also be a cable communication module, for example, a human interface device (HID) or a Universal Serial Bus (USB) interface, for signal or data communication via a cable.

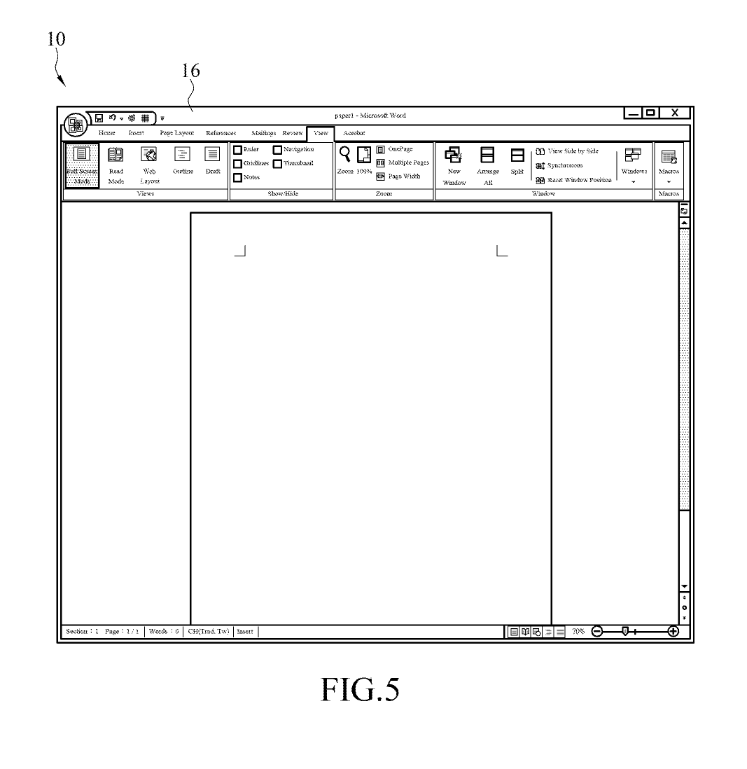

As shown FIG. 2, the foreground detection module 11 of the computer device 10 may be an application or firmware installed in the computer device 10 to detect the usage status of the computer device 10 to output foreground status information P. The foreground status information P corresponds to a foreground application the computer device 10 is currently executing in a foreground. The first communication module 15 of the computer device 10 is electrically connected to the foreground detection module 11 to output the foreground status information P. For example, a plurality of applications may be installed in the computer device 10, such as word processing programs (Microsoft Word, Microsoft Excel), aided design programs (AutoCAD, Pro/ENGINEER), audio/video playback programs (Media Player, RealPlayer), web browser programs (Google Chrome, Internet Explorer) and more. A user can execute one or more applications and display a corresponding window on the display screen 16 of the computer device 10, and the foreground application refers to an application that is currently running in the foreground. For example, the user executes two applications of Microsoft Word and AutoCAD. If the user is operating Microsoft Word (as shown in FIG. 5), Microsoft Word is a foreground application (also referred to as a user-controlled application), while AutoCAD is running in the background and is temporarily unavailable to the user. Similarly, when the user switches to manipulate the AutoCAD window, AutoCAD becomes the foreground application, while Microsoft Word operates in the background. The foreground detection module 11 of the computer device 10 can detect which application (Microsoft Word or AutoCAD) is currently the foreground application to output the foreground state information P. For example, the foreground detection module 11 can detect the foreground application according to the codes or identifiers of the applications.

As shown in FIG. 1 and FIG. 2, in this embodiment, the mobile device 20 is exemplified by a smart phone, which can be connected to the computer device 10 from the outside of the computer device 10. The mobile device 20 includes a second communication module 25, a touch screen 21 and a quick menu module 22. The second communication module 25 is communicatively connected to the first communication module 15 to receive the foreground status information P. The second communication module 25 may be a wireless communication module, such as a Wi-Fi module, an 802.11 module, a Bluetooth module, or a ZigBee module to wirelessly receive the foreground status information P transmitted from the first communication module 15. Alternatively, the second communication module 25 may be a cable communication module, such as a micro USB interface or a USB-C interface, to receive the foreground status information P transmitted from the first communication module 15 through the network. However, the instant disclosure is not limited thereto.

As shown in FIG. 1 and FIG. 2, the quick menu module 22 of the mobile device 20 may be an application or firmware installed in the mobile device 20. The quick menu module 22 is electrically connected to the second communication module 25 and the touch screen 21 to correspondingly provide and display a foreground quick menu Q on the touch screen 21 according to the foreground status information P. The foreground quick menu Q includes a plurality of foreground function options T applicable to the foreground application. For example, the quick menu module 22 may be a computer program. The computer program may be an application stored in a computer readable storage medium (such as a USB memory). Alternatively, the computer program may also be an application downloaded from a web platform (such as Apple's application store (App Store)).

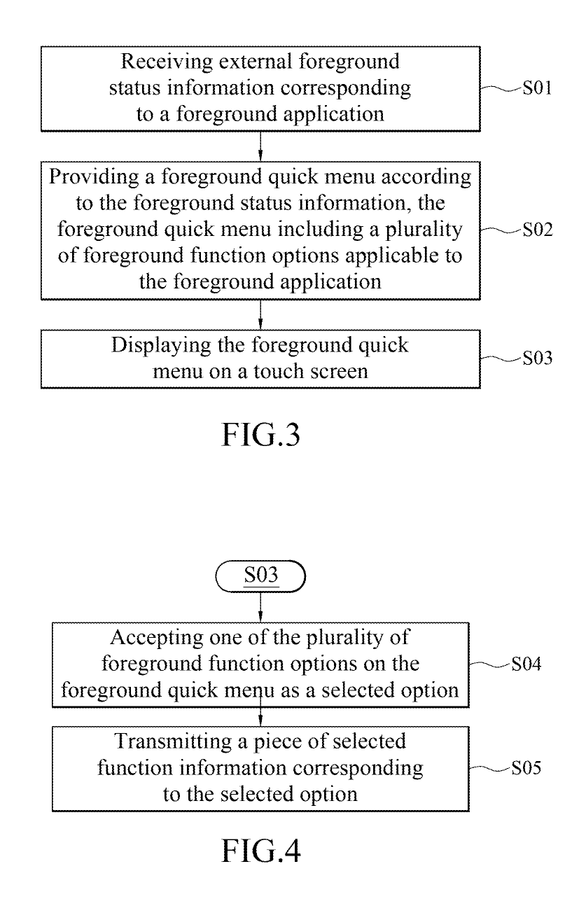

As stated above, in FIG. 3, in one embodiment, the quick menu module 22 can be downloaded into the mobile device 20 to perform Step S01 to Step S03. First, Step S01 is performed to receive external foreground status information P corresponding to a foreground application. For example, as shown in FIG. 1 and FIG. 2, the mobile device 20 can receive the foreground status information P transmitted by the first communication module 15 of the computer device 10 through the second communication module 25. The quick menu module 22 is electrically connected to the second communication module 25 to receive the foreground status information P and, thereby, learn the foreground application (for example, Microsoft Word, Pro/ENGINEER or Media Player, etc.) that the computer device 10 is currently running in the foreground.

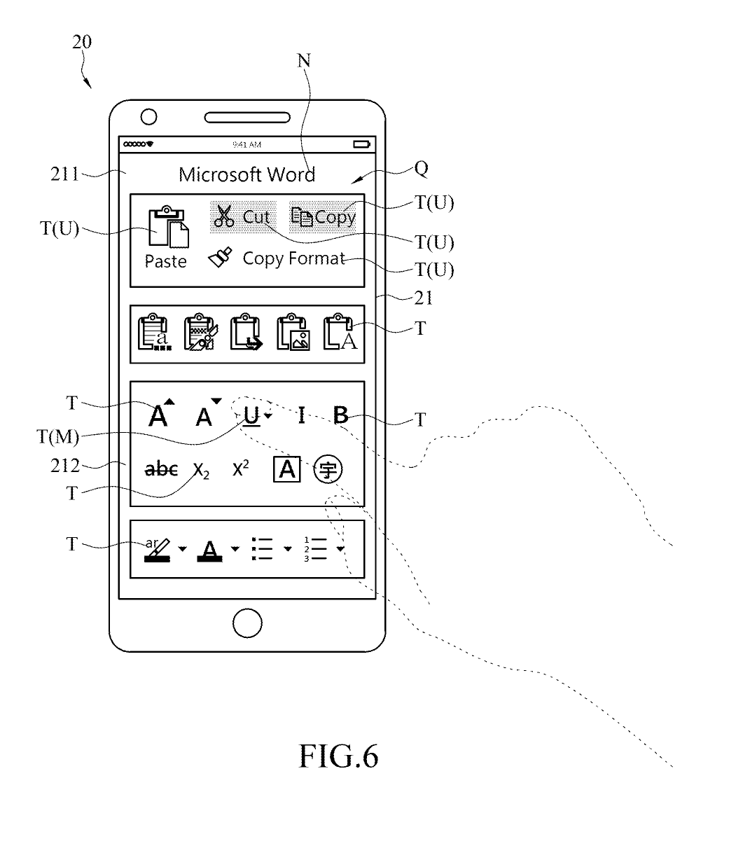

As shown in FIG. 3, after Step S01, Step S02 and Step S03 are performed. In Step S02, the foreground quick menu Q is provided according to the foreground status information P. The foreground quick menu Q includes a plurality of foreground function options T applicable to the foreground application. In Step S03, the foreground quick menu Q is displayed on the touch screen 21. As shown in FIG. 5 and FIG. 6, assuming that the foreground application the computer device 10 is currently executing in the foreground is Microsoft Word, the quick menu module 22 of the mobile device 20 learns that the foreground application is Microsoft Word according to the foreground status information P transmitted from the computer device 10 so as to provide and display a foreground quick menu Q corresponding to Microsoft Word on the touch screen 21 of the mobile device 20. As shown in FIG. 6, the foreground quick menu Q may include virtual function buttons (i.e., the foreground function option T) such as Paste, Copy Format, Zoom Out, Zoom In, Fonts, Underline, Strikeouts, Subscripts, Superscripts, etc., which are applicable to Microsoft Word. The user can click any one of the foreground function options T on the touch screen 21 by touch to perform a corresponding function. In one embodiment, the foreground quick menu Q may further include the name information N (as shown in FIG. 6) of the corresponding foreground application to facilitate user identification.

As stated above, for example, in FIG. 4, after the foreground quick menu Q is displayed on the touch screen 21 (Step S03), Step S04 and Step S05 are performed. In Step S04, one of the plurality of foreground function options T on the foreground quick menu Q is accepted as a selected option. In Step S05, a piece of selected function information corresponding to the selected option is transmitted. For example, referring to FIG. 5 and FIG. 6, assuming that when a user wants to underline certain words during the operation of Microsoft Word, the user can select the certain words through the mouse or the keyboard and then use the finger to click on the “underline” foreground function option T (as shown in the foreground function option T corresponding to the finger in FIG. 6) on the touch screen 21 of the mobile device 20. The quick menu module 22 of the mobile device 20 accepts the “underline” foreground function option T as a selected option and transmits a piece of selected function information corresponding to the “underline” function. After receiving the selected function information, the computer device 10 completes underlining the certain words according to the selected function information.

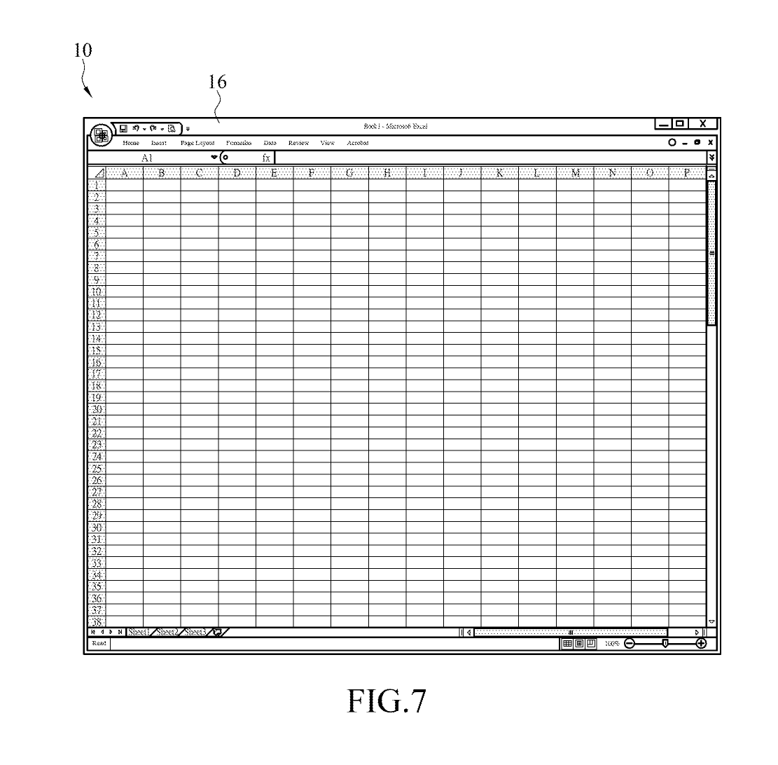

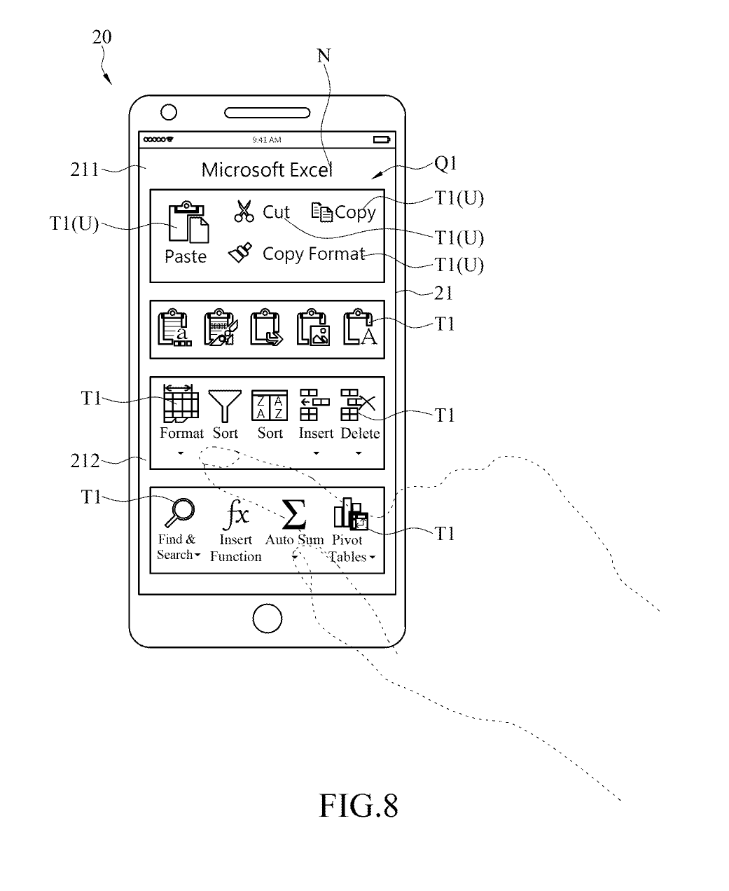

As shown in FIG. 7, in one embodiment, when the foreground application of the user's computer device 10 is switched from Microsoft Word to another application (here, it is switched to Microsoft Excel), the quick menu module 22 of the mobile device 20 learns that the foreground application of the computer device 10 is switched to Microsoft Excel according to the foreground status information P transmitted by the computer device 10 and provides and displays a foreground quick menu Q1 corresponding to Microsoft Excel on the touch screen 21. The foreground quick menu Q1 may include a plurality of foreground function options T1 applicable to Microsoft Excel. As shown in FIG. 8, the foreground quick menu Q1 includes virtual function buttons (i.e., the foreground function options T1) applicable to Microsoft Excel such as Format, Filter, Sort, Insert Function, Add-ins, Pivot Tables, etc. The user can perform a corresponding function by selecting any of the foreground function options T1 on the touch screen 21 by touch.

Therefore, in the embodiment of the instant disclosure, by connecting the mobile device 20 to the computer device 10 to display the foreground quick menu Q corresponding to the foreground application of the computer device 10, the foreground function options T can be clicked by touch such that the foreground application quickly performs the corresponding function. Therefore, the user does not need to go through the layers in the window corresponding to foreground application to find the desired function options, or remember the keyboard shortcut corresponding to each function of each foreground application. The benefits of intuition and convenience, thereby achieving the advantages of more intuitive and convenient operation.

As shown FIG. 2, in one embodiment, the foreground status information P may include version information corresponding to the foreground application. For example, applications are often updated over time and there is a difference between the old version and the new version, for example, Microsoft Word 2007 to Microsoft Word 2017 or AutoCAD 2007 to AutoCAD 2017. The old version and the new version will differ in functionality. For example, the new version, compared to the old version, has added more features. The foreground detection module 11 of the computer device 10 can further detect the version of the foreground application to provide version information such that the quick menu module 22 of the mobile device 20 can provide different foreground quick menus Q according to different version information. For example, assuming that the foreground application detected by the foreground detection module 11 is Microsoft Word 2010, the quick menu module 22 provides a foreground quick menu Q applicable to Microsoft Word 2010. Assuming that the foreground application detected by the foreground detection module 11 is Microsoft Word 2017, the quick menu module 22 provides a foreground quick menu Q applicable to Microsoft Word 2017, and so on. In this way, when the application in the computer device 10 is upgraded to a new version, the quick menu module 22 can also provide a corresponding foreground quick menu Q.

As shown in FIG. 6, in one embodiment, the plurality of foreground function options T of the foreground quick menu Q may include at least one general function option U. For example, in FIG. 6, the foreground function options T such as “Paste”, “Copy Format”, “Cut” and “Copy” on the foreground quick menu Q are general function options U. The general function options U are options that are applicable to multiple applications such as Microsoft Word and Microsoft Excel. In Step S03 of FIG. 3, a plurality of general function options U on the foreground quick menu Q may be displayed in a specific region on the touch screen 21. As shown in FIG. 6, a plurality of general function options U are displayed in the upper region 211 on the touch screen 21, while the other foreground function options T that are not general function options U are displayed in the lower region 212 on the touch screen 21. However, the instant disclosure is not limited thereto. Therefore, referring to FIG. 6 and FIG. 8, when the foreground application on the computer device 10 is switched from Microsoft Word to Microsoft Excel, the quick menu module 22 of the mobile device 20 can only change the foreground function options in the foreground function options on the touch screen 21. For example, the plurality of foreground function options T in the lower region 212 in lower region 212 is replaced with the plurality of foreground function options T1 in FIG. 8 to further reduce the computation of the quick menu module 22.

Referring to FIG. 6, in one embodiment, at least one of the foreground function options T on the foreground quick menu Q may be a custom option. For example, the quick menu module 22 may include a plurality of foreground function options T (for example, 100 foreground function options T) applicable to the foreground application. The quick menu module 22 allows the user to select or determine which foreground function options T to be displayed on the touch screen 21. For example, the user may select some of the more frequently used foreground function options T or the foreground function options T corresponding to keyboard shortcuts that are more difficult to remember to be displayed on the touch screen 21 to meet the needs of different users.

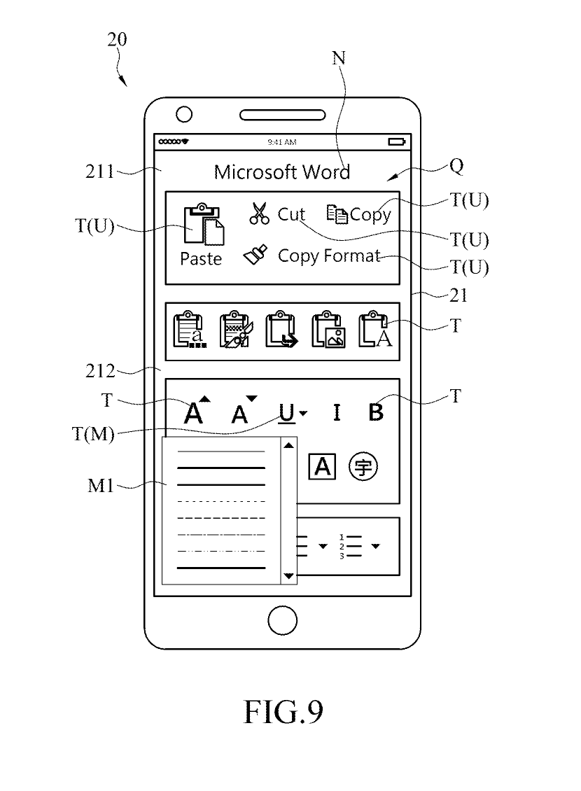

As shown in FIG. 6, in one embodiment, at least one of the plurality of foreground function options T on the foreground quick menu Q may be a foreground menu M. In this embodiment, the “underline” foreground function option T on the foreground quick menu Q is a drop-down foreground menu M. Referring to FIG. 6 and FIG. 9, when the user clicks an arrow on the foreground menu M, a drop-down menu M1 may be popped out for the user to select the “underline” form. In other embodiments, the foreground menu M may also be a pop-up menu or a hierarchical menu, which this embodiment is not limited to.

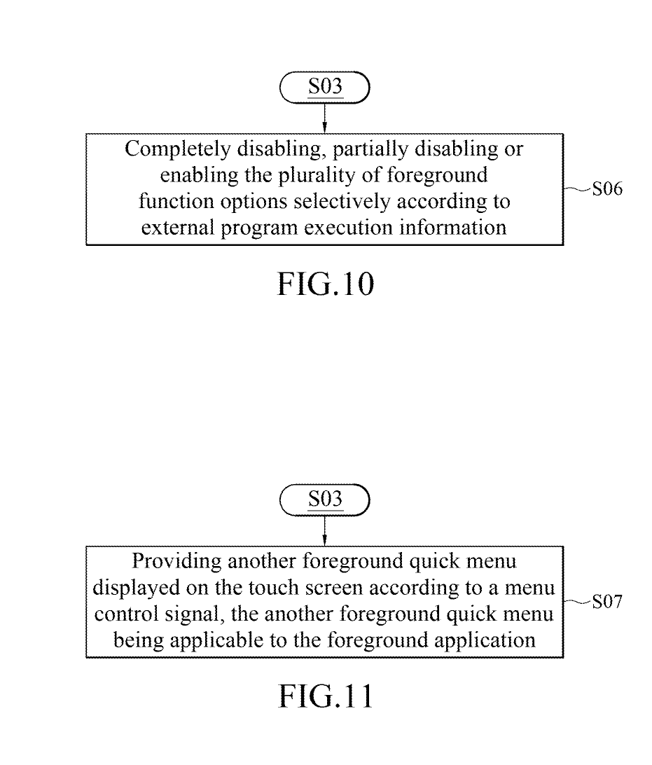

As shown in FIG. 10, in one embodiment, after displaying the foreground quick menu Q on the touch screen 21 (Step S03), Step S06 may be performed to completely disable, partially disable or enable the plurality of foreground function options T selectively according to external program execution information. For example, as shown in FIG. 2, FIG. 5 and FIG. 6, in one embodiment, the foreground detection module 11 of the computer device 10 can further detect the controlled state of the foreground application to provide program execution information. The foreground status information P transmitted by the first communication module 15 may include the above-mentioned program execution information. As shown in FIG. 5, the foreground application that the computer device 10 is currently operating in the foreground is Microsoft Word. When the user is inputting a piece of text in the window instead of selecting text, the foreground detection module 11 of the computer device 10 can detect the operation state and provide corresponding program execution information. The quick menu module 22 of the mobile device 20 can partially disable the foreground function options T (for example, the “cut” and “copy” foreground function options T in the reversed state in FIG. 6) according to the program execution information to prevent the user from accidentally touching and causing malfunction or non-action. For example, if the user wants to perform the “Copy Format” function but mistakenly clicks the “cut” foreground function option T near “copy format”, resulting in a situation where the corresponding action is not performed. When the user selects a piece of text in the window, the foreground detection module 11 of the computer device 10 can detect the operating state and provide the corresponding program execution information. The quick menu module 22 of the mobile device 20 enables the “cut” and “copy” foreground function options T according to the program execution information such that the user can cut or copy the text.

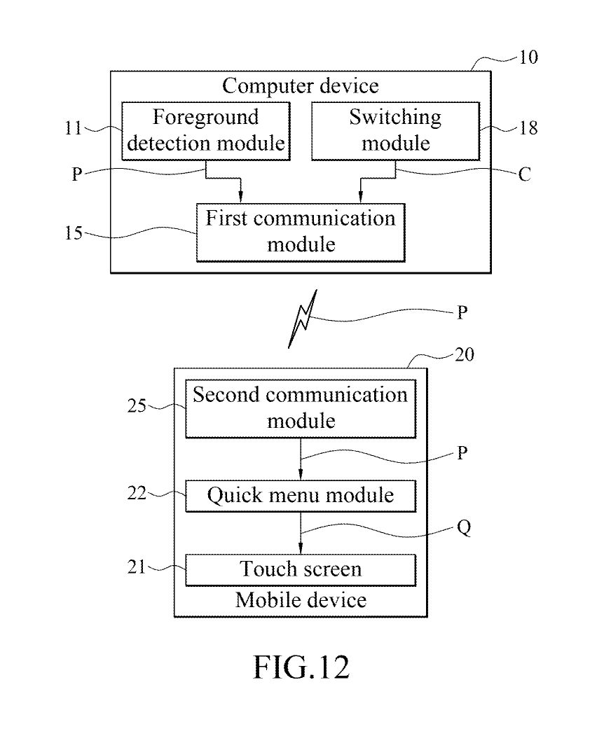

As shown in FIG. 11, in one embodiment, after displaying the foreground quick menu Q on the touch screen 21 (Step S03), Step S07 may be performed to provide another foreground quick menu displayed on the touch screen 21 according to a menu control signal. The another foreground quick menu is applicable to the foreground application. As shown in FIG. 1 and FIG. 12, the computer device 10 may include a switching module 18. The switching module 18 may be a keyboard 171, a touch pad 172, or other input devices (for example, a mouse) of the computer device 10. In addition, the switching module 18 can selectively output a menu control signal C. For example, assuming that the switching module 18 is a keyboard 171, the switching module 18 can preset a shortcut key. When the user inputs a shortcut key, the switching module 18 can output a menu control signal C correspondingly. Alternatively, assuming that the switching module 18 is a touch panel 172, the switching module 18 can preset a touch action (such as a horizontal slide). When the user performs a touch action on the touch panel 172, a menu control signal C can be provided correspondingly. The switching module 18 can be electrically connected to the first communication module 15 to output the menu control signal C to the mobile device 20 via the first communication module 15. When the quick menu module 22 of the mobile device 20 receives the menu control signal C, another foreground quick menu applicable to the foreground application may be switched to be displayed on the touch screen 21. For example, as shown in FIG. 5, assuming that the foreground application that the computer device 10 is currently running in the foreground is Microsoft Word, the quick menu module 22 of the mobile device 20 provides and displays a foreground quick menu Q corresponding to Microsoft Word according to the foreground status information P on the touch screen 21. When the user wants to execute a function other than the foreground function options T on the foreground quick menu Q, the switching module 18 can be operated to provide a menu control signal C such that the touch screen 21 on the mobile device 20 displays another foreground quick menu (omitted in the drawing) including different foreground function options applicable to Microsoft Word for the user to perform other functions.

In other embodiments, the switching module 18 may also be a touch screen 21 on the mobile device 20. The switching module 18 may preset a touch action (such as a horizontal slide). When the user touches the touch screen 21, the menu control signal C is provided correspondingly such that the quick menu module 22 switches to another foreground quick menu to be displayed on the touch screen 21 (omitted in the drawing).

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A computer input system, comprising:
a computer device comprising a foreground detection module and a first communication module, said foreground detection module detecting a usage status of said computer device to output foreground status information, said foreground status information corresponding to a foreground application said computer device is executing in a foreground, said first communication module being electrically connected to said foreground detection module and outputting said foreground status information; and
a mobile device comprising a second communication module, a touch screen, and a quick menu module, said second communication module being communicatively connected to said first communication module to receive said foreground status information, said quick menu module being electrically connected to said second communication module and said touch screen such that said quick menu module correspondingly provides and displays a foreground quick menu on said touch screen according to said foreground status information, and said foreground quick menu comprising a plurality of foreground function options applicable to said foreground application.

2. The computer input system of claim 1, wherein said foreground status information comprises version information corresponding to said foreground application.

3. The computer input system of claim 1, wherein said foreground status information comprises program execution information, said program execution information indicates the controlled state of said foreground application, and said quick menu module further completely disables, partially disables or enables said plurality of foreground function options selectively according to said external program execution information.

4. The computer input system of claim 1, wherein said plurality of foreground function options comprises at least one general function option, said at least one general function option being displayed in a specific region on said touch screen.

5. The computer input system of claim 1, wherein at least one of said plurality of foreground function options is a custom option.

6. The computer input system of claim 1, wherein at least one of said plurality of foreground function options is a foreground menu.

7. The computer input system of claim 1, wherein said computer device or said mobile device comprises a switching module, said switching module being capable of selectively outputting a menu control signal, said quick menu module of said mobile device switching to another foreground quick menu displayed on said touch screen upon receiving said menu control signal, and said another foreground quick menu being applicable to said foreground application.

8. The computer input system of claim 1, wherein said mobile device is a smart phone, a tablet computer or a personal digital assistant.

9. A mobile device, comprising:
a communication module receiving external foreground status information, said foreground status information corresponding to a foreground application being currently executed;
a quick menu module being electrically connected to said communication module such that said quick menu module provides a foreground quick menu according to said foreground status information; and
a touch screen being electrically connected to said quick menu module to display said foreground quick menu, wherein said foreground quick menu comprises a plurality of foreground function options applicable to said foreground application.

10. The mobile device of claim 9, wherein said foreground status information further comprises version information corresponding to said foreground application.

11. The mobile device of claim 9, wherein said foreground status information further comprises program execution information, said program execution information indicates the controlled state of said foreground application, and said quick menu module further completely disables, partially disables or enables said plurality of foreground function options selectively according to said external program execution information.

12. The mobile device of claim 9, wherein said plurality of foreground function options comprises at least one general function option, said at least one general function option being displayed in a specific region on said touch screen.

13. The mobile device of claim 9, wherein at least one of said plurality of foreground function options is a custom option.

14. The mobile device of claim 9, wherein at least one of said plurality of foreground function options is a foreground menu.

15. A computer readable storage medium provided with a computer program applicable to a mobile device, said mobile device comprising a touch screen, said computer program being capable of being downloaded into said mobile device to execute the following steps:
receiving external foreground status information corresponding to a foreground application;
providing a foreground quick menu according to said foreground status information, wherein said foreground quick menu comprises a plurality of foreground function options applicable to said foreground application; and
displaying said foreground quick menu on said touch screen.

16. The computer readable storage medium of claim 15, wherein said computer program is capable of being downloaded into said mobile device to further execute the following steps:
accepting one of said plurality of foreground function options on said foreground quick menu as a selected option; and
transmitting a piece of selected function information corresponding to said selected option;

17. The computer readable storage medium of claim 15, wherein said computer program is capable of being downloaded into said mobile device to further execute the following step:
completely disabling, partially disabling or enabling said plurality of foreground function options selectively according to external program execution information, wherein said program execution information indicates the controlled state of said foreground application.

18. The computer readable storage medium of claim 15, wherein said plurality of foreground function options comprises at least one general function option such that said computer program is capable of being downloaded into said mobile device to further execute the following step:
displaying said at least one general function option in a specific region on said touch screen.

19. The computer readable storage medium of claim 15, wherein said computer program is capable of being downloaded into said mobile device to further execute the following step:
providing another foreground quick menu displayed on said touch screen according to a menu control signal, said another foreground quick menu being applicable to said foreground application.

20. The computer readable storage medium of claim 15, wherein at least one of said plurality of foreground function options is a custom option.

21. The computer readable storage medium of claim 15, wherein at least one of said plurality of foreground function options is a foreground menu.
